(19) United States
(12) Patent Application Publication
(10) Pub. No.: US 2008/0077942 A1
(43) Pub. Date: Mar. 27, 2008

(54) SYSTEM, METHOD, AND API FOR AUTOMATIC DIGITAL LIBRARY CREATION

(76) Inventors: David MacMillan, Emerald Hills, CA (US); Charles Davis, San Jose, CA (US)

Correspondence Address: Wilson & Ham;PMB: 348, 2530 Berryessa Road, San Jose, CA, 95132, US

(21) Appl. No.: 11/781,244

(22) Filed: Jul. 21, 2007

Related U.S. Application Data
(60) Provisional application No. 60/807,965, filed on Jul. 21, 2006.

(51) Int. Cl. G06F 3/048

(52) U.S. Cl. 719/328

(57) ABSTRACT

A system, method, and API for automatic digital library creation is disclosed. One aspect of the invention involves a computer-implemented method in which a storage server: receives data from a plurality of authorities; determines content that meets a thematic profile of a user based at least on: data received from a first authority in the plurality of authorities, and data received from a second authority in the plurality of authorities; and receives and stores at least some of the determined content.

### RELATED APPLICATIONS

This application is entitled to the benefit of U.S. Provisional Patent Application Ser. No. 60/807,965, filed on Jul. 21, 2006, and is related to U.S. patent application Ser. No. 11/337,199, filed Jan. 20, 2006, entitled “Compact, Integrated Storage and Networking Apparatus and Uses Thereof,” which are incorporated by reference herein in its entirety.

### TECHNICAL FIELD

The disclosed embodiments relate generally to computer networks. More particularly, the disclosed embodiments relate to a system, method, and application programming interface (API) for automatic digital library creation in networks, such as home networks and other local area networks (LANs).

### BACKGROUND

There is a well-documented trend in which information that historically was in physical form is being replaced with digital information that can be stored on disk drives, semiconductor memories, digital tapes, and other digital storage products. This trend includes the replacement of audio tapes and physical CDs with downloadable audio files (including MP3 files), the replacement of printed photos with electronic photos, the replacement of video tapes and physical DVDs with downloadable videos, the replacement of physical books and magazines with web pages and downloadable books (including Acrobat files and the like), and the replacement of physical letters with email.

There is also a well-documented recognition of “long tail” distributions in media, by which is meant there are a huge number of media items (such as books, web pages, music, videos, and movies) that have small audiences. Part of the reason the “long tail” is attracting attention is that collectively the long tail audiences represent a large total market opportunity that can be cost effectively addressed using digital media distribution, even though for a given media item the audience may be small.

There are reports that the media industry is undergoing a fundamental shift from primarily a hits business, in which a few books, films and music releases generate the bulk of the industry profits, to a long tail media business, with substantial revenues in the “long tail” that cater to the unique personal needs of individuals. Some believe that long tail revenues, in total, could be larger than the total revenue for hits based media. Thus, there is tremendous interest in finding efficient ways to help users locate and acquire long tail media content.

For example, Wired Magazine ran an article “The Long Tail” by Chris Anderson, Wired, October 2004, which discusses the Long Tail. This was followed by an article with additional elaboration, also entitled the “The Long Tail” and posted by Chris Anderson at http://www.changethis.com/10.LongTail.

Wired further emphasized the impact of the Long Tail on media companies with the article “His Space” by Spencer Reiss, Wired, July 2006. In this article, Rupert Murdoch said, “To find something comparable, you have to go back 500 years to the printing press, the birth of mass media—which, incidentally, is what really destroyed the old world of kings and aristocracies. Technology is shifting power away from the editors, the publishers, the establishment, the media elite. Now it's the people who are taking control.” The article continues by explaining that it is this train of thought that led Murdoch to purchase the website MySpace for $580 million.

The nature of long tail distributions is that each item of media content in the long tail has a relatively small audience. A key challenge for consumers is how to locate and collect long tail media. Historically, in a hits-based media business, a consumer could amass a large holding of media by buying pre-packaged collections. These pre-packed collections came in all sizes and forms, from multiple songs on an audio tape or CD, to boxed sets of music, movies and books, to newspapers and magazines (i.e., collections of news and articles), to subscriptions for magazines, CDs and books (e.g., Book-of-the-month club, CD-of-the-month club) and so forth.

Current approaches used for collecting long tail media are highly inefficient. A user must either invest the time to seek out and select each item to add to their collection, or suffer the higher cost and clutter of unwanted items associated with buying a pre-packaged collection.

Associated with the transition to long tail media models is an explosion in the quantity of media, which makes searching and acquiring the most enjoyable media a bigger challenge for users. Niche genres that would not have been economically viable under a hits-based media model become viable under a long tail model. Even though they may appeal to very few users, these niche genres crowd the media landscape, making it harder for users to find what they want. Chris Anderson's article at the aforementioned web site cites the following long tail statistics to highlight the explosion in media: Amazon has 2.3 million books vs. a bricks-and-mortar Barnes & Noble store with 130,000; and Rhapsody has 735,000 songs versus a bricks-and-mortar Wal-mart store with 39,000. Both examples represent a roughly 20:1 expansion in quantity due to the long tail. Television has seen a similar explosion, from a few network channels in the 70's to hundreds of channels in the 1990s (thanks to cable and satellite) and now millions of downloads via the Internet (including sites that range from YouTube to video downloads at Apple's iTunes).

Consumers trying to locate the media they are most likely to enjoy face a paradoxical dilemma—although there is probably media available that they will find more satisfying than they would under the hits-based media model, the very long tail trends that make this media available also makes it more difficult to find and acquire due to the sheer increase in overall media that is presented to the user.

Thus, there is a need to simplify the creation and use of a tailored digital library of media from the entire range of available content (both hits and long tail), a digital library that fits the unique preferences of a user.

### SUMMARY

The present invention reduces or eliminates the problems described above.

One aspect of the invention involves a computer-implemented method in which a computer configured to receive and store content in accordance with algorithms in a thematic profile: receives input from a user via an API implementation to modify the thematic profile; and receives and stores content in accordance with the modified thematic profile.

Another aspect of the invention involves a computer configured to receive and store content in accordance with algorithms in a thematic profile. The computer includes one or more processors, memory, and a program. The program is stored in the memory and configured to be executed by the one or more processors. The program includes: instructions for receiving input from a user via an API implementation to modify the thematic profile; and instructions for receiving and storing content in accordance with the modified thematic profile.

Another aspect of the invention involves a computer-program product that includes a computer readable storage medium and a computer program mechanism embedded therein. The computer program mechanism includes instructions, which when executed by a computer configured to receive and store content in accordance with algorithms in a thematic profile, cause the computer to: receive input from a user via an API implementation to modify the thematic profile; and receive and store content in accordance with the modified thematic profile.

Another aspect of the invention involves a computer configured to receive and store content in accordance with algorithms in a thematic profile, comprising: means for receiving input from a user via an API implementation to modify the thematic profile; and means for receiving and storing content in accordance with the modified thematic profile.

Another aspect of the invention involves a computer-implemented method in which a first computer with a thematic profile of a first user communicates at least a portion of the thematic profile of the first user to a second computer of a second user. The second computer is configured to receive and store content in accordance with the communicated portion of the thematic profile of the first user and a thematic profile of the second user.

Another aspect of the invention involves a first computer with a thematic profile of a first user. The first computer includes one or more processors, memory, and a program. The program is stored in the memory and configured to be executed by the one or more processors. The program includes instructions for communicating at least a portion of the thematic profile of the first user to a second computer of a second user. The second computer is configured to receive and store content in accordance with the communicated portion of the thematic profile of the first user and a thematic profile of the second user.

Another aspect of the invention involves a computer-program product that includes a computer readable storage medium and a computer program mechanism embedded therein. The computer program mechanism includes instructions, which when executed by a first computer with a thematic profile of a first user, cause the first computer to communicate at least a portion of the thematic profile of the first user to a second computer of a second user. The second computer is configured to receive and store content in accordance with the communicated portion of the thematic profile of the first user and a thematic profile of the second user.

Another aspect of the invention involves a computer-implemented method in which a first computer associated with a first user: receives at least a portion of a thematic profile associated with a second user from a second computer; and receives and stores content in accordance with the received thematic profile.

Another aspect of the invention involves a first computer associated with a first user. The first computer includes one or more processors, memory, and a program. The program is stored in the memory and configured to be executed by the one or more processors. The program includes: instructions for receiving at least a portion of a thematic profile associated with a second user from a second computer; and instructions for receiving and storing content in accordance with the received thematic profile.

Another aspect of the invention involves a computer-program product that includes a computer readable storage medium and a computer program mechanism embedded therein. The computer program mechanism includes instructions, which when executed by a first computer associated with a first user, cause the first computer to: receive at least a portion of a thematic profile associated with a second user from a second computer; and receive and store content in accordance with the received thematic profile.

Another aspect of the invention involves a first computer associated with a first user, comprising: means for receiving at least a portion of a thematic profile associated with a second user from a second computer; and means for receiving and storing content in accordance with the received thematic profile.

Another aspect of the invention involves a computer-implemented method in which a storage server: receives data from a plurality of authorities; determines content that meets a thematic profile of a user based at least on: data received from a first authority in the plurality of authorities, and data received from a second authority in the plurality of authorities; and receives and stores at least some of the determined content.

Another aspect of the invention involves a storage server. The storage server includes one or more processors, memory, and a program. The program is stored in the memory and configured to be executed by the one or more processors. The program includes: instructions for receiving data from a plurality of authorities; instructions for determining content that meets a thematic profile of a user based at least on: data received from a first authority in the plurality of authorities, and data received from a second authority in the plurality of authorities; and instructions for receiving and storing at least some of the determined content.

Another aspect of the invention involves a computer-program product that includes a computer readable storage medium and a computer program mechanism embedded therein. The computer program mechanism includes instructions, which when executed by a storage server, cause the storage server to: receive data from a plurality of authorities; determine content that meets a thematic profile of a user based at least on: data received from a first authority in the plurality of authorities, and data received from a second authority in the plurality of authorities; and receive and store at least some of the determined content.

Another aspect of the invention involves a storage server with: means for receiving data from a plurality of authorities; means for determining content that meets a thematic profile of a user based at least on: data received from a first authority in the plurality of authorities, and data received from a second authority in the plurality of authorities; and means for receiving and storing at least some of the determined content.

Another aspect of the invention involves a computer-implemented method in which a storage server with a set of content items to be obtained: receives data from one or more authorities on when content items in the set may be obtained; determines an acquisition plan that optimizes which content items in the set are obtained when there are availability conflicts between content items in the set; and obtains content items in the list according to the plan.

Another aspect of the invention involves a storage server. The storage server includes one or more processors, memory, and a program. The program is stored in the memory and configured to be executed by the one or more processors. The program includes: instructions for receiving data from one or more authorities on when content items in the set may be obtained; instructions for determining an acquisition plan that optimizes which content items in the set are obtained when there are availability conflicts between content items in the set; and instructions for obtaining content items in the list according to the plan.

Another aspect of the invention involves a computer-program product that includes a computer readable storage medium and a computer program mechanism embedded therein. The computer program mechanism includes instructions for obtaining a set of content items, which when executed by a storage server, cause the storage server to: receive data from one or more authorities on when content items in the set may be obtained; determine an acquisition plan that optimizes which content items in the set are obtained when there are availability conflicts between content items in the set; and obtain content items in the list according to the plan.

Another aspect of the invention involves a storage server with a set of content items to be obtained, comprising: means for receiving data from one or more authorities on when content items in the set may be obtained; means for determining an acquisition plan that optimizes which content items in the set are obtained when there are availability conflicts between content items in the set; and means for obtaining content items in the list according to the plan.

Thus, the invention greatly simplifies the creation and use of digital content libraries. Automatic (i.e., unattended) operation in accordance with a thematic profile greatly simplifies content library creation for users. By setting up one or more thematic profiles, a user can easily create a massive personalized library of digital media.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed computer system in accordance with embodiments of the present invention.

FIG. 2 is a block diagram illustrating a storage server in accordance with embodiments of the present invention.

FIG. 3 is a block diagram illustrating an exemplary client in accordance with embodiments of the present invention.

FIG. 4 is a block diagram illustrating an exemplary thematic profile in accordance with embodiments of the invention.

FIG. 5 is a flowchart representing a method of configuring a thematic profile in accordance with embodiments of the present invention.

FIGS. 6A & 6B are schematic screen shots of exemplary graphical user interfaces for configuring a thematic profile in accordance with embodiments of the present invention.

FIG. 7 is a flowchart representing a method of using an API to modify a thematic profile in accordance with embodiments of the present invention.

FIG. 8 is a flowchart representing a method of sending and receiving thematic profiles in accordance with embodiments of the present invention.

FIG. 9 is a flowchart representing a method of gathering content using more than one authority in accordance with embodiments of the present invention.

FIG. 10 is a flowchart representing a method of making and using a content acquisition plan in accordance with embodiments of the present invention.

FIG. 11 is a schematic screen shot of an exemplary graphical user interface for inputting content acquisition information in accordance with embodiments of the present invention.

FIG. 12 is a flowchart representing a content acquisition process using thematic profiles in accordance with embodiments of the present invention.

### DESCRIPTION OF EMBODIMENTS

A system, method, and API for automatic library creation for digital content are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

Specific embodiments may include one or more of the following capabilities:
the ability to work with any type of digital media, including, without limitation, text, web pages, music, photographs and other images, videos, movies, and TV shows
the ability to work with both hits-based media and long tail media
the ability to create one or more detailed thematic profiles to select and screen the media to be collected in the library
the ability for each user to have one or more personal thematic profiles, and for multiple users to accumulate their own libraries
the ability to identify candidate media for addition using one or more authorities, and to use one or more additional authorities to qualify whether the candidate media should be added to the library
the ability to extend the authorities for sourcing and screening media, plus the ability for users and developers to add their own processing algorithms for processing media sources, screening criteria and data from authorities. These algorithms could include capabilities not yet in widespread commercial use, such as image recognition, and can be applied to a library already established to further select content or to eliminate content.
the ability for users to share their thematic profiles with other users (e.g., to accelerate the growth of each user's library)
the ability to alert the user as new material is added to the library
the ability to connect to a user's network, whether wired or wireless, to enable media collection and distribution to client devices, wherever located
the ability to control the library size, including limiting addition of new material and selectively erasing older material

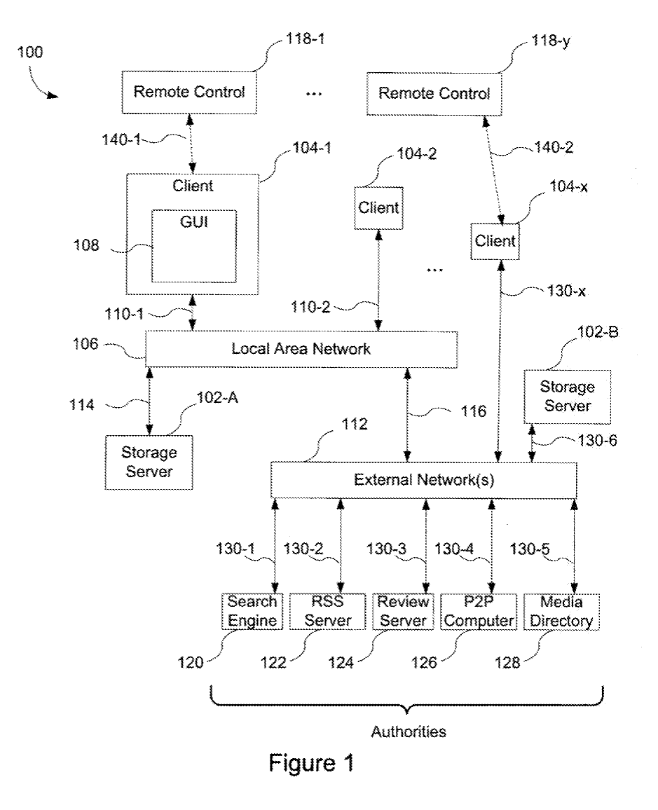

FIG. 1 is a block diagram illustrating an exemplary distributed computer system 100 in accordance with embodiments of the invention. FIG. 1 shows various functional components that will be referred to in the detailed discussion that follows. This system includes client devices 104, storage server 102, and LAN 106 for interconnecting these components. LAN 106 (e.g., a home network) may also be connected to external network(s) 112, such as the Internet. Network connections 110, 114, and 116 to LAN 106 and network connections 130 to external network 112 can be either wireline or wireless connections, and may be permanent or intermittent. An intermittent network is one where a connection to a device is not always available. For example, a dial-up network or VPN network may be intermittent because a connection must be established before traffic can move. A network may be intermittent due to range or propagation limitations (e.g. wireless 802.11 networks, cellular networks, infrared networks). A network may be intermittent due to connection issues (e.g., a USB port may extend the reach of a network to portable electronics that may be disconnected from the USB cable, or any network device may be powered off or unplugged).

Client devices 104 can be any of a number of digital electronic devices (e.g., a digital video recorder, digital media adapter, digital video camera, digital still camera, digital music player, Internet radio, personal digital assistant, cell phone, gaming console, handheld gaming device, desktop computer, laptop computer, handheld computer, or a combination thereof) used to enable the activities described below. Some clients 104 may have a display with a graphical user interface (GUI) 108. Some clients may only be used for recording content (e.g., a security camera); some clients may only be used for playing content (e.g., a digital media adapter); and some clients may be used for both recording and playing content (e.g., a digital video recorder). When a client is used to record content, a record-capable client is assumed and, when a client is used to play content, a play-capable client is assumed.

Some clients 104 may have their own remote controls 118 for managing the content that is acquired, stored, displayed, and/or transferred on the corresponding client. The use of a remote control 118 typically provides a simpler user interface that more users are comfortable with. The remote control creates a television-viewing-like interface that is familiar to users, rather than a personal-computer-like interface that may confuse or intimidate some users. In some embodiments, one remote control 118 is used to manage multiple clients 104 in LAN 106. In some embodiments, one remote control 118 is used to manage all of the clients 104 in LAN 106. Each remote control may control one or more of clients 104 via connection 140. Connection 140 may be an infrared or radio frequency connection.

The external network 112 may include:
storage server(s) 102-B;
client(s) 104-x, which may be controlled by remote control 118-y via connection 130-x;
search engine(s) 120 that may send search results to storage server 102 or a client 104;
RSS server(s) 122 that may send RSS feeds (or portions thereof) to storage server 102 or a client 104;
content review/ratings server(s) 124 that may send reviews and/or ratings of content to storage server 102 or a client 104;
peer-to-peer computer(s) 126 (e.g., computers with BitTorrent clients) that may send content to storage server 102 or a client 104; and
media directory or guide(s) 128 (e.g., You Tube, Yahoo! TV, Google Video, or Live365) that provides programming information that may be used by storage server 102 to control the content that is acquired by the storage server or by some client devices (e.g., television programs for a digital video recorder or radio programs for an Internet radio).

As used herein, an authority is a networked information source. For example, an authority may be a search engine 120, RSS server 122, review server 124, P2P computer 126, media directory 128, or other networked computer system.

An authority may include a list of content, such as a reviewer's top 10 movies, or a list of all horror movies, or all music by Madonna before 1995, or all books on Amazon by John Le Carre.

A further example of an authority is a site such as the Internet Movie Database (IMDB.COM). IMDB has explicit lists of content, for example the top 100 ranked movies. IMDB also includes metadata about movies such as the director, year, title and the like, along with reviewer ratings information, including ratings by sex and age group. Other examples of authorities are Gracenote (a CD Database, formerly the CDDB database), and FreeDB, both of which include metadata about music. MegaBrainz, MeeVee's website, Yahoo TV listings, and TV Guide's listings on their website are examples of authorities focused on TV. Further examples of authorities include AMG Lasso, All Music Guide, All Media Guide, All Movie Guide, All Game Guide, MusicBrainz, Linkara, and Relatable's TRM. Some of these authorities use acoustic fingerprinting, and other authorities may use image recognition or any type of fingerprinting, watermark, or other content identification and/or classification mechanisms. Some of these mechanisms may require that some or all of the content and/or a description relating to the content and/or other information be communicated to the authority to retrieve the authority's information regarding the content.

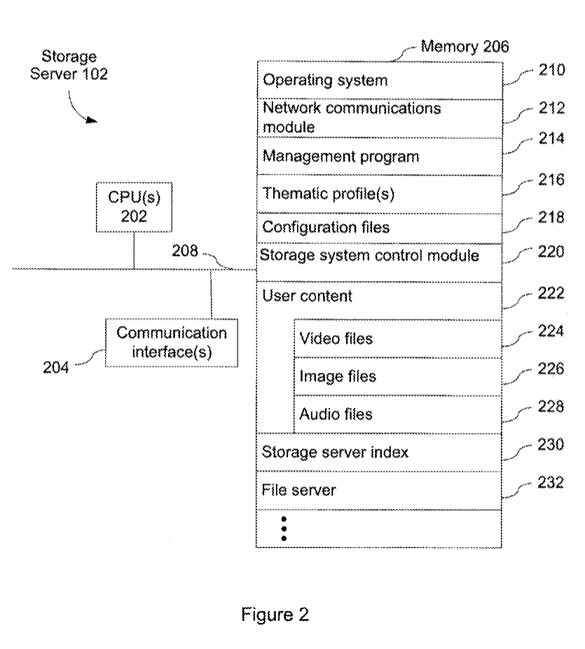

As used herein, a library is a collection of stored digital information. For example, storage server 102 may contain a library (e.g., in user content 222 in FIG. 2). A library can be located on a single system such as storage server 102, or may be located across multiple systems. For example, some or all of clients 104 may also have storage capability and be part of a library. One or more remotely located systems may be part of a library. Portable devices may hold some or all of a library.

FIG. 2 is a block diagram illustrating storage server 102 in accordance with embodiments of the present invention. Storage server 102 typically includes one or more processing units (CPUs) 202, one or more network or other communications interfaces 204, memory 206, and one or more communication buses 208 for interconnecting these components. The communication buses 208 may include circuitry (sometimes called a chipset) that interconnects and controls communications between system components. Storage server 102 may optionally include a graphical user interface (not shown), which typically includes a display device, a keyboard, and a mouse or other pointing device. Memory 206 may include high-speed random access memory and may also include non-volatile memory, such as one or more magnetic or optical storage disks and/or flash memory. Memory 206 may store the following programs, modules and data structures, or a subset or superset thereof:
operating system 210 that includes procedures for handling various basic system services and for performing hardware dependent tasks;
network communications module (or instructions) 212 that is used for connecting storage server 102 to other computers (e.g., clients 104, authorities, and other storage servers) via the one or more communications network interfaces 204 (wired or wireless) and LAN 106 (FIG. 1) and to external network(s) 112, such as the Internet, wide area networks, other local area networks, metropolitan area networks, and so on;
integrated management program 214 that configures and manages storage (e.g., in accordance with profile 216) and serving functions (e.g., using input received from a menu-based GUI 108 and a remote control 118 or a browser-based GUI 108);
thematic profile(s) 216 that are descriptions of content that is to be put into a library;
configuration files 218 that are produced and/or revised by management program 214;
storage system control module 220 that manages secure storage of user content (e.g., with capabilities for RAID 0, RAID 1, RAID 1+0, RAID 5 and/or other redundant storage techniques using multiple storage devices; and/or with disk scrubbing that automatically finds and repairs inconsistencies in the stored content and its computed parity in the storage devices);
user content 222 that includes files (e.g., video files 224, image files 226, audio files 228, and/or other data) received from authorities in LAN 106 (e.g., clients 104) and/or authorities in external network 112 (e.g., search engine 120, RSS server 122, review server 124, P2P computer 126, and media directory 128);
storage server index 230 that includes a list of the content 222 stored in memory 206; and
file server 232 that serves content 222 to clients 104 (e.g., by streaming content 222 to a client 104 and/or by sending content 222 to a client 104 for download and storage on the client).

In some embodiments, the total capacity of the storage devices used to store user content 222 is one terabyte or more. In some embodiments, the capacity can be expanded by connecting more storage devices (e.g., magnetic or optical disk drives) to storage server 102.

Each of the above identified modules and applications in FIG. 2 includes a set of instructions for performing a function described above. These modules (i.e., sets of instructions) need not be implemented as separate software programs, procedures or modules, and thus various subsets of these modules may be combined or otherwise rearranged in various embodiments. In some embodiments, memory 206 may store a subset of the modules and data structures identified above. Furthermore, memory 206 may store additional modules and data structures not described above.

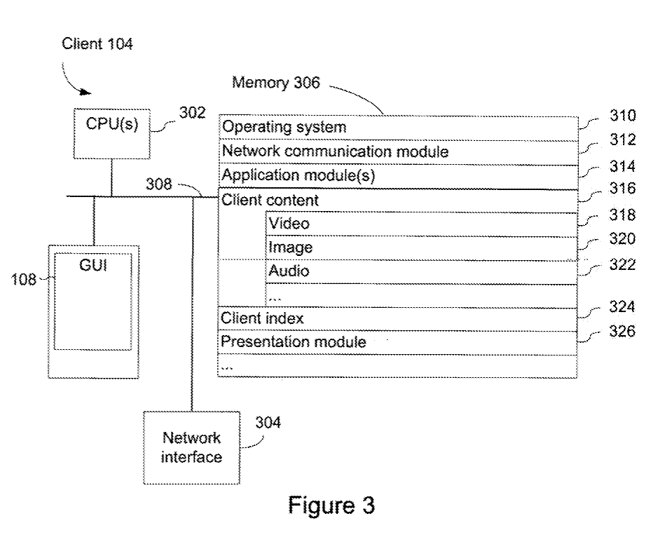

FIG. 3 is a block diagram illustrating an exemplary client 104 in accordance with embodiments of the present invention. As noted above, client 104 may include graphical user interface (GUI) 108. Client 104 typically includes one or more processing units (CPUs) 302, one or more network or other communications interfaces 304, memory 306, and one or more communication buses 308 for interconnecting these components. The communication buses 308 may include circuitry (sometimes called a chipset) that interconnects and controls communications between system components. Memory 306 may include high-speed random access memory and may also include non-volatile memory, such as one or more magnetic or optical storage disks and/or flash memory. Client memory 306 may store the following programs, modules and data structures, or a subset or superset thereof:
operating system 310 that includes procedures for handling various basic system services and for performing hardware dependent tasks;
network communication module (or instructions) 312 that is used for connecting client 104 to other computers (e.g., storage server 102) via the one or more communications network interfaces 304 (wired or wireless) and LAN 106 (FIG. 1) and to external network(s) 112, such as the Internet, wide area networks, other local area networks, metropolitan area networks, and so on;
application module(s) 314 for creating, receiving, and/or storing content 316 on client 104;
client content 316 that may include digital video 318, image 320, audio 322, and/or other data files;
client index 326 that includes a list of the client content 316 stored in client memory 306; and
presentation module 328 for displaying client content 316.

Each of the above identified modules and applications in FIG. 3 includes a set of instructions for performing a function described above. These modules (i.e., sets of instructions) need not be implemented as separate software programs, procedures or modules, and thus various subsets of these modules may be combined or otherwise re-arranged in various embodiments. In some embodiments, memory 306 may store a subset of the modules and data structures identified above. Furthermore, memory 306 may store additional modules and data structures not described above.

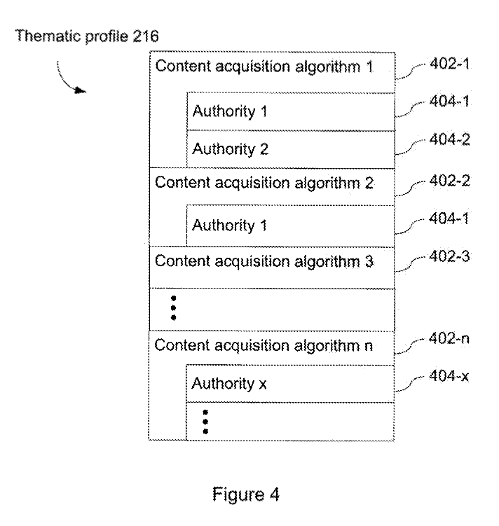

FIG. 4 is a block diagram illustrating an exemplary thematic profile in accordance with embodiments of the invention. As used in the specification and claims, a “thematic profile” (e.g., thematic profile 216) is a description of content that is to be added to a library. In some embodiments, a thematic profile includes content acquisition algorithms 402, which in turn, may include rules 404 for interacting with authorities. A contact acquisition algorithm 402 may include: no rules for interacting with authorities (e.g., 402-3); rules for interacting with one authority (e.g., 404-1 in 402-2); or rules for interacting with two or more authorities (e.g., 404-1 and 404-2 in 402-1). As explained below, the thematic profile enables automatic digital library creation for a user. As used herein, a “user” may be an individual or a group of people (e.g., a family in a home setting or workers in a business setting).

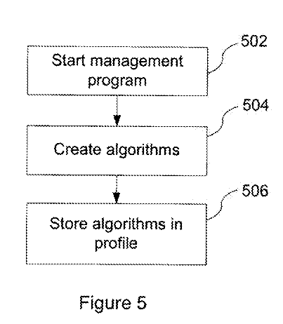

FIG. 5 is a flowchart representing a method of configuring a thematic profile 216 in accordance with embodiments of the present invention. The processes shown in FIG. 5 (or subsets or supersets thereof) are performed by storage server 102 in LAN 106 (FIG. 1). It will be appreciated by those of ordinary skill in the art that one or more of the acts described may be performed by hardware, software, or a combination thereof.

Storage server 102 starts (502) management program 214. Management program 214 creates (504) content acquisition algorithms 402. In some embodiments, the algorithms are based on input received from a user (e.g., in response to user selections with a remote control 118 or via user selections with a web browser at a client 104). If the storage server 102 has no display, then the input received from the user may be via a client 104 with a GUI 108.

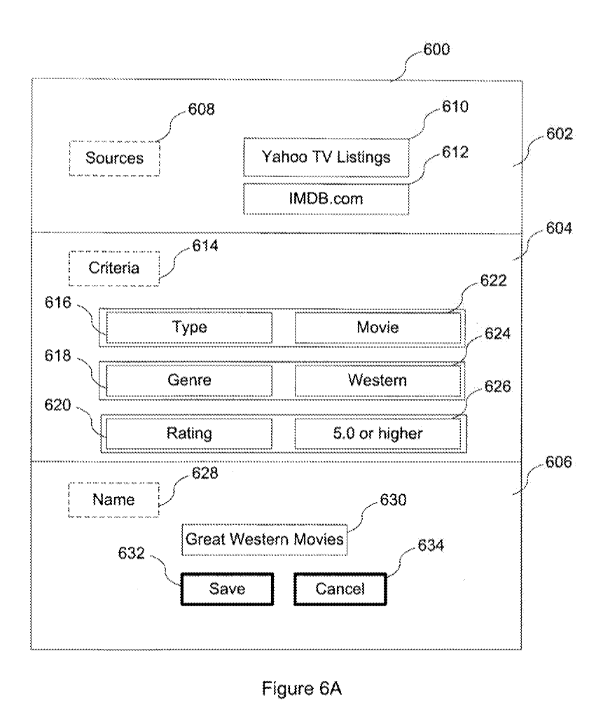

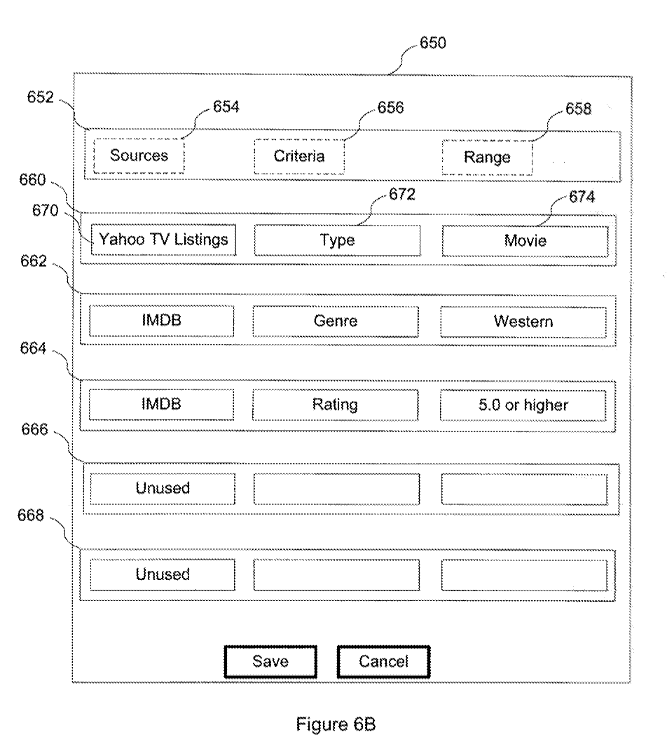

A user may easily configure a thematic profile 216 by simply making selections (e.g., with a remote control 118 or web browser) from GUIs such as those shown in FIGS. 6A & 6B. The thematic profile configuration GUIs may be viewed on client devices with displays or on storage server 102 if it includes a display. Configuring a thematic profile 216 with input via a remote control 118 is particularly simple for most users because it provides a familiar television-viewing-like experience.

Management program 214 stores (506) the algorithms 402 in profile 216.

As described below, a thematic profile may also be created on a specific system, such as storage server 102-A, by receiving input from another system, such as storage server 102-B, which may be located remotely (shown in FIG. 1) or locally (not shown in FIG. 1).

FIGS. 6A & 6B are schematic screen shots of exemplary graphical user interfaces for configuring a thematic profile in accordance with embodiments of the present invention.

In FIG. 6A, the thematic profile configuration GUI 600 consists of three sections 602, 604 and 606.

Section 602 has a label with the word “Sources” 608 and two boxes 610 and 612 for specifying which two authorities should be used in identifying, selecting, or otherwise determining content. The specification could be via a pick-list, by IP address with or without port number, by system name, by fully qualified domain name, or by other techniques that allow identification of the authorities.

Section 604 has a label “Criteria” 614 and one or more boxes 616, 618 and 620 for specifying criteria. There are also boxes 622, 624 and 626 for specifying an acceptable range for each criterion. In this example, the boxes for the criteria are each associated with a corresponding box for the acceptable range (616 with 622, 618 with 624, and 620 with 626).

There will typically be a capability for naming and saving a thematic profile 216. For example, in FIG. 6A there is, in Section 606, a label “Name” 628, a box 630 for entering a name (e.g., “Great Western Movies”), and a Save button 632. A Cancel button 634 allows closing of the GUI 600 without saving.

There are a wide variety of ways to configure a thematic profile. FIG. 6B illustrates another approach. Thematic profile configuration GUI 650 has at the top row 652 three column headings, “Source” 354, “Criteria” 356 and “Range” 358, and one or more records 660, 662, 664, 666, and 668 underneath. The profile can be configured by selecting as many records as needed, each record (e.g., 660) consisting of an authority as a “Source” (e.g. “Yahoo TV” in 670), a Criteria (e.g. “Type” in 672) and a Range (e.g. “Movie” in 674). One or more records (e.g. 666 and 668) may be unused or more records may be added.

In the examples in FIGS. 6A & 6B, a particular item of content is matched against the thematic profile and if all criteria from the specified authority Sources match the specified Range for each, then the particular item of content is selected as a candidate for storage.

In some embodiments, a more complex thematic profile 216 may be constructed in which Boolean operations are performed. For example, the Criteria 656 might be (Type=Movie or Type=TV Series) and Genre=Western or Actor=“John Wayne”, in which case both TV shows and Movies that are Westerns would match, as well as any content of any type with John Wayne listed as an actor. In this example, one or more authorities may be specified for determining the Type, Genre and Actor.

In some embodiments, even more complex thematic profiles may be constructed, including profiles that score content using one or more algorithms to determine whether the content is desired. The algorithms may be provided by the storage server 102 vendor, by an authority, by the user, or by some other source.

Storage server 102 may support one or more users. For example, a storage server used in a home may have Dad, Mom, Boy and Girl as users. Thematic profiles may be specific to a single user or shared between multiple users (e.g. the kids may have one or more shared thematic profiles relating to kids shows, the parents may have one or more thematic profiles relating to adult content, the entire family may have one or more thematic profiles relating to shared interests, and so forth).

The thematic profile 216 may be stored in a variety of forms. One convenient representation is in a database system that may be provided as part of storage server 102. If a database is used, it may be of any type that is appropriate for the complexity of the thematic profiles used. For example, for simpler thematic profiles, the database may be a flat file database (i.e., a single table). A more complex set of templates for thematic profiles may be stored in a relational database. An embodiment that allowed specification of computer code for scoring may use an object oriented database structure. Security structures to prevent one user from accessing or changing another user's thematic profile or resultant stored library content may also be implemented as desired.

An API for Thematic Profiles

In some embodiments, an API for creating, modifying, and otherwise manipulating thematic profiles that build libraries of digital content includes the following functions: NewThematicProfile, ListThematicProfile, GetThematicProfile, EditThematicProfile, and DeleteThematicProfile. Each of these functions may be implemented as a function call or subroutine call with passed parameters, or using any other well-known approach for intersystem communication (e.g., between two storage servers 102 or between a storage server 102 and a client 104 with a user interface for manipulating thematic profiles).

The NewThematicProfile call passes a data structure having the following information: the user input information for building a new thematic profile (e.g., as illustrated in FIGS. 6A and 6B); user identification; and any security credentials required, such as a password if a security model is implemented in the called system. The called computer system either creates a new thematic profile in response to the request and reports back success to the calling computer system, or it returns an error. This mechanism allows one computer to share its thematic profiles with a second computer, e.g., by having the first computer system make a NewThematicProfile call to the second computer system.

The ListThematicProfile call requests that the called computer system list all of its thematic profiles. The call includes the necessary user identification and security credentials. The called system provides a data structure with this information, which for bandwidth efficiency may be limited to identifiers for all thematic profiles the calling system is permitted to see, and perhaps brief information about each, such as its human-readable name. In some embodiments, the original call specifies what information is to be provided about each thematic profile.

The GetThematicProfile call sends an identifier for a specific thematic profile (which may have been obtained, for example, by a previous ListThematicProfile call). The call includes the necessary user identification and security credentials. This call provides a mechanism for a computer system to explicitly request the information in a thematic profile from another computer system. The called system either returns the information associated with the thematic profile or returns an error. If the ListThematicProfile call has an option to allow all information about all thematic profiles to be returned, then there may not be a need for a GetThematicProfile call.

The EditThematicProfile call identifies which thematic profile is to be edited. The call includes the necessary user identification and security credentials. The called system returns the information for the identified thematic profile and locks that profile to prevent another user from editing it. The calling system may then edit the information and return it with a StoreThematicProfile call. The called system then stores the new thematic profile information in the locked profile and unlocks the profile. Appropriate safeguards including timeouts and detection of loss of network connectivity may be added to ensure that in the event of an incomplete transaction, the profile would not remain permanently locked.

The DeleteThematicProfile call sends an identifier for a thematic profile that is to be deleted. The call includes the necessary user identification and security credentials. The called system either deletes the identified thematic profile or reports an error.

The previous paragraphs outline one embodiment of an API for manipulating thematic profiles. Other known methods for creating records, deleting records, browsing records and editing records in distributed computing environments may also be use to provide an API for creating and modifying thematic profiles used to build a library of content.

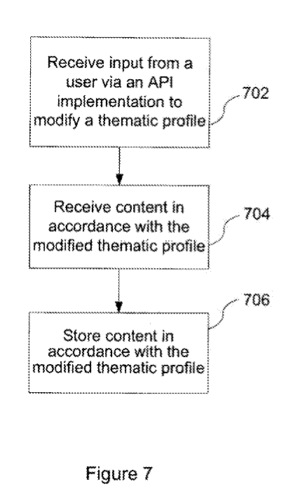

FIG. 7 is a flowchart representing a method of using an API to modify a thematic profile in accordance with embodiments of the present invention. The processes shown in FIG. 7 (or subsets or supersets thereof) may be performed by storage server 102 or any other computer configured to receive and store content in accordance with algorithms in a thematic profile. It will be appreciated by those of ordinary skill in the art that one or more of the acts described may be performed by hardware, software, or a combination thereof.

Input from a user is received (702) via an API implementation to modify a thematic profile.

Content is received (704) and stored (706) in accordance with the modified thematic profile. In some embodiments, the modified thematic profile includes new algorithms for determining which content is to be received and stored. In some embodiments, the new algorithms include rules for contacting authorities. The new algorithms are input via the API implementation.

Sending and Receiving Thematic Profiles or Portions Thereof

Thematic profiles can be shared between storage servers 102, subject to whatever security mechanisms are implemented for allowing others to see or modify thematic profiles. For example, a person (Dad) may share a thematic profile for building a football library with his friends. Thematic profiles may be shared through a wide variety of communication mechanisms, such as via peer-to-peer networks, via e-mail, or via posting to a web site.

Thematic profiles may also be shared via a communications mechanism that is specifically provided for the purpose of sharing thematic profiles between storage servers. A communications channel may optionally provide a mechanism for searching and discussing shared thematic profiles and related content.

In some embodiments, a thematic profile may be used as an authority. The thematic profile being used as an authority can reside on the same storage server as the thematic profile that uses it, or it may reside on another computer system. This allows construction of thematic profiles on one storage server that include a rule or algorithm based on thematic profile(s) on other computing system(s). For example, one person (Alice) may have a thematic profile A that specifies that Alice's storage server should store all content that is specified by some or all of the thematic profiles established by another friend (Bob). Bob's thematic profiles may reside on Bob's storage server, but be communicated to Alice's storage server. This sharing of thematic profiles may be subject to whatever security mechanisms are in place on Bob and Alice's storage servers. In some embodiments, Bob's thematic profile could also refer to Alice's thematic profile, in which case Bob and Alice's storage servers would record the same material (subject to availability).

Two or more users could also arrange to share stored content, by passing content from one user's library to the other(s), or could share content between each library or some subset of the libraries. Users could also share content by providing each other with access to their libraries. For clarity, the sharing models discussed here are different from sharing thematic profiles: this discussion concerns sharing content, whereas sharing thematic profiles shares information (e.g., algorithms) on what content is to be added to a library.

One application of thematic profile sharing is star websites. A pop star (e.g., Madonna) could create a thematic profile specifying her favorite content and share that with users. Thematic profile sharing is a significant extension of the current approach of having stars offer collections of favorite songs, books and the like, in that thematic profiles specify a way to automatically identify and collect favorite content, without actually having to identify the specific content itself.

Thematic profiles can also be combined to create narrower or broader selection criteria. Narrowing criteria may be accomplished by combining the criteria of two or more thematic profiles with an AND logical operation, such that rules in each thematic profile must be met for corresponding content to be stored. Widening the criteria may be accomplished by combining the criteria of two or more thematic profiles using the OR logical operation. More complex Boolean or numeric scoring or algebraic systems may be used to create higher-order thematic templates from simpler ones.

Combinations of the forgoing can create a rich environment of selection criteria for content to be added to a library. For example, a thematic profile for a music fan may specify that content should be stored in the fan's library if at least two of three pop stars named by the fan (e.g., Madonna, Britney Spears, and Mariah Carey) also like the content, according to each star's shared thematic profiles (each pop star potentially having multiple shared thematic profiles that would need to be examined).

Each pop star may also publish a specific list of favorite content identified by name, which list may be instead of or in addition to sharing one or more thematic profiles. As described earlier, such a specific list of content may be considered to be all or part of an authority.

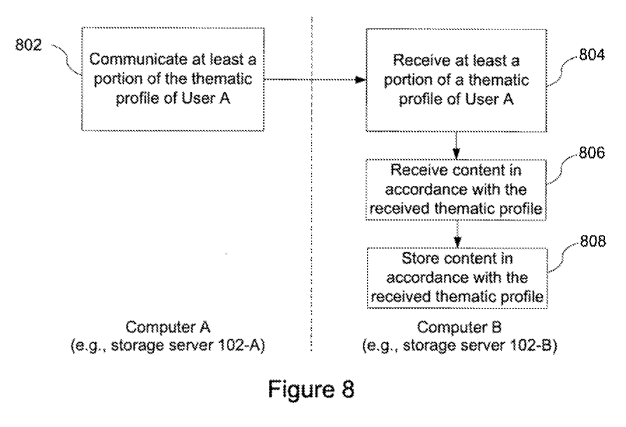

FIG. 8 is a flowchart representing a method of sending and receiving thematic profiles in accordance with embodiments of the present invention. The processes shown in FIG. 8 (or subsets or supersets thereof) are performed by two computers with respective thematic profiles 216 for respective users (e.g., storage server 102-A with thematic profile(s) 216-A of User A and storage server 102-B with thematic profile(s) 216-B of User B). It will be appreciated by those of ordinary skill in the art that one or more of the acts described may be performed by hardware, software, or a combination thereof.

A first computer (e.g., storage server 102-A) with a thematic profile of a first user communicates (802) at least a portion of the thematic profile of the first user to a second computer (e.g., storage server 102-B) of a second user. The second computer is configured to receive and store content in accordance with the communicated portion of the thematic profile of the first user and a thematic profile of the second user. In some embodiments, the communicated thematic profile includes algorithmic information. In some embodiments, the communicated thematic profile includes instructions to contact one or more authorities. In some embodiments, the authorities include websites with content guides, such as Yahoo TV. In some embodiments, the authorities include websites with content reviews, such as IMDB.com. In some embodiments, the communicated thematic profile includes one or more metadata specifications, which may concern movie, TV, music or photo information. In some embodiments, communicating the thematic profile includes remote execution of code on the first computer system initiated by the second computer system (i.e., a pull model). In some embodiments, communicating the thematic profile includes remote execution of code on the second computer system initiated by the first computer system (i.e., a push model).

The second computer associated with the second user receives (804) at least a portion of the thematic profile associated with the first user from the first computer.

The second computer (e.g., storage server 102-B) receives (806) and stores (808) content in accordance with the received thematic profile.

Gathering Content Using More than One Authority

The storage server 102 creates and/or receives one or more thematic profiles (e.g., as described above with respect to FIGS. 6A and 6B). The storage server 102 then processes the thematic profiles to identify content that meets the thematic profiles. For the example used in FIG. 6A, the storage server 102 examines the Yahoo TV listings periodically to identify any movies that are classified as Westerns. For each such movie, the storage server 102 checks the IMDB website to see if the movie is rated 5 or higher. Any movies passing this set of criteria can then be received and stored (e.g., from a website with the movie; using BitTorrent or a similar file transfer mechanism; or recording the movie with a digital video recorder client 104 (e.g., a TiVo DVR or a Windows Media Server-compatible DVR) and then transferring the movie to the storage server 102 for storage).

In some embodiments, checking a web site such as Yahoo TV listings or IMDB may require navigating through multiple pages. These pages may all be on the same website, the same server, or may cross servers and websites. There are known screen scraping and web spidering techniques for navigating a series of web pages. These techniques include having the spider or other navigating system automatically enter information (e.g. into forms or search fields or provide login credentials such as username and password) and/or alter URLs or other navigational pointers (e.g. to include search or other parameters in the URL or navigational pointer). Such techniques can be used, for example, to acquire TV listings for a specific time for a specific reception type (e.g. over-the-air, satellite, or cable) for all channels (or some specific channel or channels) from Yahoo TV or other electronic listing, and to then check another authority (such as IMDB) to find the ratings for a particular movie that appeared on the TV listing. Some web sites, such as freedb, provide detailed information on interfacing with their web site (e.g., see the material at http://www.freedb.org/modules.php?name=Sections&sop=listarticles &secid=2).

For the example in FIG. 6A, the content of interest may be provided over a television broadcast. Storage Server 102 may program a client 104 to record the show. This may be done via a programming interface provided by the device. This may be, for example, a software API accessible via an Ethernet network, or it may be through a device connected to the storage server that emulates the infrared beams from a remote control 118 so as to schedule the recording, similar such devices customarily being used between VCRs and cable TV or satellite set top boxes to facilitate TV channel selection.

The content processed by the storage server may come from a variety of sources. It can include broadcast material, streamed material, on-demand material (e.g., video on demand), material downloaded from an Internet site, or any other networked source. The material retrieved can be photos, music, video, text, or any other digital content. Where the content has a real-time nature (such as music or video), the content can be provided in real time or in non-real time (either faster or slower, an example of slower being a trickle feed of video). The content can be in native format, or compressed, encoded, encrypted or otherwise transmitted in a form different from how it is used.

The capability of checking two or more authorities (e.g., the Yahoo TV listings and the IMDB web site) represents a powerful screening capability. The ability to use authorities of different types—for example, an electronic program guide website and a ratings website—enhances the automatic (i.e., unattended) creation of digital libraries.

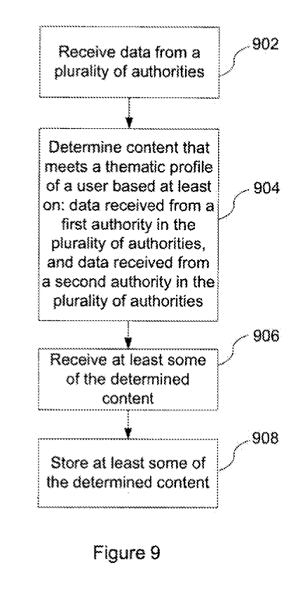

FIG. 9 is a flowchart representing a method of gathering content using more than one authority in accordance with embodiments of the present invention. The processes shown in FIG. 9 (or subsets or supersets thereof) may be performed by storage server 102 or any other computer configured to receive and store content in accordance with a thematic profile. In some embodiments, the storage server is located in a home network of the user. It will be appreciated by those of ordinary skill in the art that one or more of the acts described may be performed by hardware, software, or a combination thereof.

Data is received (902) from a plurality of authorities. In some embodiments, the plurality of authorities include a plurality of scheduled program guides. In some embodiments, the plurality of authorities include a plurality of content guides such as CDDB (aka Gracenote), TiVo Electronic Program Guide, or Yahoo TV.

In some embodiments, the data received from the plurality of authorities includes metadata about the content. In some embodiments, the data received from the plurality of authorities includes commentary on the content. In some embodiments, the data received from the plurality of authorities includes reviewer ratings of the content. As used herein reviewer ratings information refers to ratings by one or more other users and/or professional reviewers, but not to maturity ratings information (e.g., G, PG, R, etc.). In some embodiments, the data received from the plurality of authorities includes maturity ratings of the content.

Content is determined (904) that meets a thematic profile of a user based at least on: data received from a first authority in the plurality of authorities, and data received from a second authority in the plurality of authorities. In some embodiments, the thematic profile is specified by the user.

In some embodiments, the data received from the first authority includes program scheduling information and the data received from the second authority includes reviewer ratings information. In some embodiments, the first authority is a website. In some embodiments, the first authority and the second authority are websites. In some embodiments, the data received from the first authority includes responses to a plurality of requests from the storage server to the first authority. In some embodiments, the received data from the first authority is used to adjust a request made to another authority (e.g., a specific program identified in a TV listing from a first authority generates a request to a second authority about reviewer ratings for the specific program).

In some embodiments, a request is sent for at least some of the determined content to a remote computer.

At least some of the determined content is received (906) and stored (908). In some embodiments, at least some of the determined content is received (906) and stored (908) in a personal library for the user.

In some embodiments, at least some of the stored content is served to the user.

Optimized Scheduling

When content is delivered according to an external schedule (e.g., TV broadcasts), the storage server 102, in processing a thematic profile, determines when the desired content will be available, so as to properly obtain it. When content can be retrieved at any time (e.g., downloaded content from a web site, content available via peer-to-peer networking such as BitTorrent, or content from a video-on-demand service), the storage server 102 may still need to determine when to retrieve the content. In any event, it can be advantageous for the storage server to determine an acquisition plan that optimizes the content that is retrieved.

The availability of content refers to when the content is available to the user. An element impacting availability is when the content may be obtained by storage server 102. For example, if it is currently Friday and the content is desired on the upcoming Sunday night, with the content being broadcast both Sunday afternoon and the following Monday afternoon, then the availability criteria can only be met by recording the Sunday broadcast. Similarly, if the availability constraint was “as soon as possible”, then the content should be recorded Sunday.

There can be availability conflicts due to conflicts within a single thematic profile (e.g., two western movies that fit a thematic profile are broadcast on different channels during overlapping time slots, and only one TV tuner client is available for recording). There can be availability conflicts between two or more thematic profiles (e.g., one thematic profile has identified a show to be recorded on one channel while another thematic profile has identified a show during an overlapping time slot on another channel, and only one TV tuner client is available for recording.) There could also be other types of availability conflicts, such as storage limits imposed per user.

The criteria of what acquisition plan is optimal will depend on the specific circumstances and may include pre-configured criteria and/or user-provided criteria for determining what is optimal. In some embodiments, an optimization plan may require comparisons between various alternatives and a ranking mechanism. When the objective is to create a choice between alternatives, a single ranking score is desirable to decide between contending alternatives. For example, one ranking scheme may maximize the number of hours of content retrieved, where the content is temporal content (this ranking is not be applicable to photo or text content). Another ranking scheme may maximize the number of megabytes stored, although the larger file sizes of video compared to music and photos and (especially) text would favor video over other formats. Another ranking scheme may have scores associated with each hour of video, each hour of music, each photograph and each amount of text, and then seek to maximize the overall score.

Another ranking scheme may attach higher scores to content targeted by one or more users. For example, parents' requests may have priority over kids' requests. Such priority may be such that requests from a preferred user always override a conflicting request from a lower priority user (absolute priority), or the priority may simply add a bias in favor of the preferred user's request (biased priority), but that bias may be overridden if sufficient other factors weight in favor of the conflicting request. Priorities can be assigned to a specific user (e.g., Dad) or to a number of users (e.g., multiple kids). Typically this assignment would be done by a privileged user so as to prevent lower priority users from simply reassigning their priorities so as to circumvent the system.

Intelligent processing of acquisition plans, including automatic rescheduling, may identify ways to avoid or minimize availability conflicts and thereby optimize content storage beyond what could be achieved without intelligent processing. For example, in the case where show A and show B are both targets to be recorded, but have overlapping time slots and only a single TV tuner client is available, further examination of the electronic program guide as part of determining the acquisition plan may uncover that show B is also being broadcast at a later time. Thus intelligent processing can result in a superior acquisition plan that optimizes the content stored by scheduling show A's recording during the overlapping time slot and scheduling show B's recording on its re-broadcast time slot. In a like manner, content that can be retrieved at any time may be scheduled into empty time slots. For example, a TV tuner capable of receiving video-on-demand on some channels could have a retrieval plan that first identifies timeslots filled by recording scheduled shows, and then the video-on-demand shows can be scheduled into idle periods.

In most cases, it is desirable for the system to proceed in an automated (i.e., unattended) fashion under the best plan it can create subject to the availability and optimization information available to it. However, capabilities can be provided to allow a user to adjust the plan manually. In some embodiments, it may be desirable to limit the changes a user can make to those that impact that user and lower priority users, and to block changes that impact the content obtained for higher priority users. There will be cases where it may not be possible to determine whether the changes will impact higher priority users—for example, where schedules for broadcast shows may not yet be available—and in these cases it would become an implementation specific decision on what powers to provide to a lower priority user.

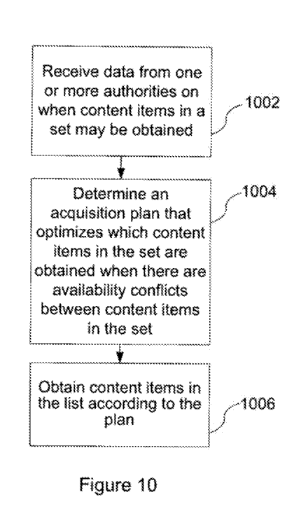

FIG. 10 is a flowchart representing a method of making and using a content acquisition plan in accordance with embodiments of the present invention. The processes shown in FIG. 10 (or subsets or supersets thereof) may be performed by storage server 102 or any other computer with a set of content items to be obtained. It will be appreciated by those of ordinary skill in the art that one or more of the acts described may be performed by hardware, software, or a combination thereof.

Data is received (1002) from one or more authorities on when content items in the set may be obtained.

An acquisition plan is determined (1004) that optimizes which content items in the set are obtained when there are availability conflicts between content items in the set. In some embodiments, determining the acquisition plan includes evaluating alternative acquisition times to resolve an availability conflict. In some embodiments, determining the acquisition plan includes superseding a user specified set of time-independent content priorities in order to circumvent an availability conflict between two or more content items in the set. In some embodiments, the plan takes into account input by a user on when at least some content items in the set need to be available. In some embodiments, the plan takes into account input by a user on the priority of at least some content items in the set.

Content items in the list are obtained (1006) according to the plan.

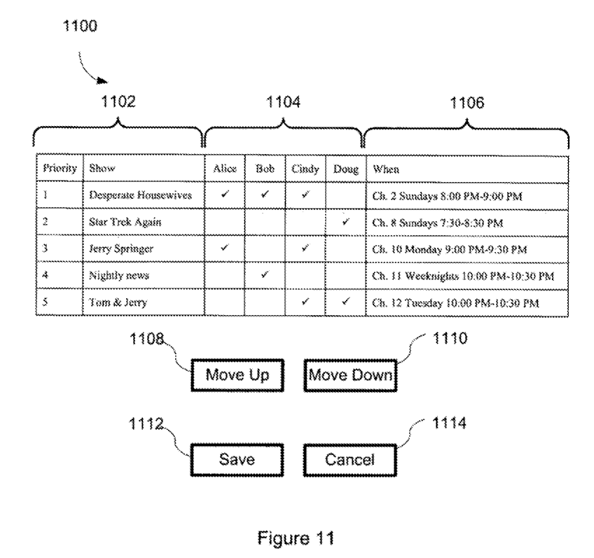

FIG. 11 is a schematic screen shot of an exemplary graphical user interface for inputting content acquisition information in accordance with embodiments of the present invention. Shows to be recorded are listed in priority order in area 1102, with lower number shows taking priority over higher number shows. Area 1104 shows by checkmark which users are associated with the thematic profiles that have requested that a show be recorded. There may also be an area 1106 showing the channel and time at which the show is recorded. Priorities of shows may be changed by highlighting the show using a mouse, remote control, or other means, and then clicking the Move Up button 1108 or the Move Down button 1110, which move the show up or down by one position in the listing respectively. A Save button 1112 and Cancel button 1114 allow the changes to be saved or cancelled.

In FIG. 11, Desperate Housewives has a priority of 1 and Star Trek Again has a priority of 2, and their time slots overlap. If there is only one recording device, Desperate Housewives would be recorded. By highlighting Star Trek Again and clicking the Move Up button 1108, Start Trek Again would move up to priority 1 and Desperate Housewives would move down to priority 2. This would now result in Star Trek Again being recorded, if the changes were saved with the Save Button 1112.

In the example shown in FIG. 11, Star Trek Again will not be recorded in the time slot shown because Desperate Housewives has higher priority. The system may reschedule recording Star Trek Again to another time slot if it is broadcast at multiple times. This rescheduling may be automatic or initiated by user request. The system may automatically choose a time slot (e.g., based on soonest broadcast or other criteria) if multiple rebroadcasts were available, or allow the user to select one. Additional buttons may be provided to allow a highlighted show to be scheduled for soonest broadcast or to otherwise establish a user's preference for the shows availability.

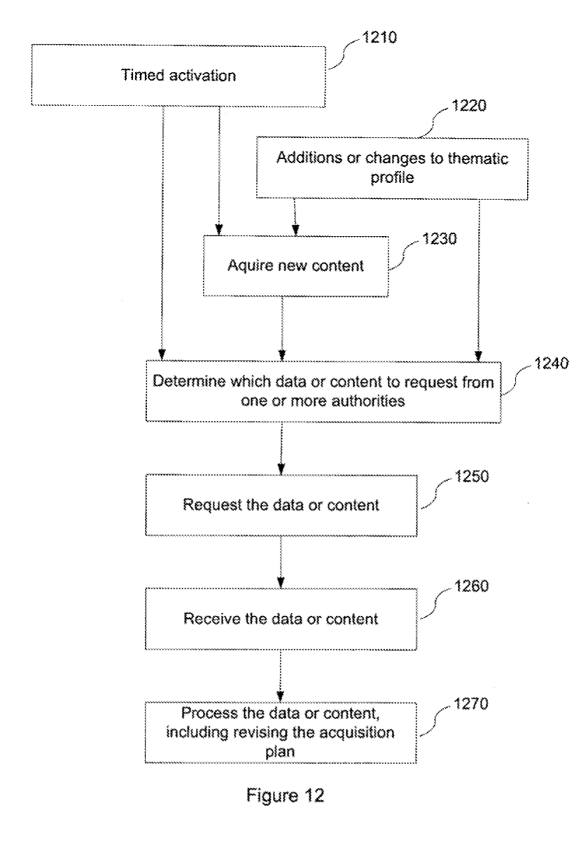

FIG. 12 is a flowchart representing a content acquisition process using thematic profiles in accordance with embodiments of the present invention. In some embodiments, timed activation 1210 occurs periodically, or when a timed recording needs to start. On timed activation 1210, if there is new content to be retrieved, then the storage server 102 acquires the new content 1230. If there are additions or changes to a thematic profile 1220 that require immediate retrieval of content, then the storage server 102 acquires the new content 1230. Otherwise, the storage server 102 examines the thematic profile(s) and scheduled events to determine which data or content to request from one or more authorities 1240. The storage server 102 then requests this data or content 1250, receives the data or content 1260, and processes the data or content, including revising the acquisition plan. If there are more authorities to consider, the storage server 102 loops back to determine which data or content to request from one or more authorities 1240. If there are no more authorities to consider, the storage server waits for the next timed activation 1210.

The foregoing description, for purpose of explanation, has been described with reference to specific embodiments. However, the illustrative discussions above are not intended to be exhaustive or to limit the invention to the precise forms disclosed. For example, although storage devices have typically been described as disk storage devices, a person of ordinary skill in the art would understand that one or more of the storage devices may also be other forms of nonvolatile storage, such as a flash memory that mimics the operation of a disk storage device. Similarly, although the embodiments are well-suited to a home network, other types of LANs may also be used (e.g., LANs in a small business, corporate, or educational setting). Many modifications and variations are possible in view of the teachings above. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method comprising: at a computer configured to receive and store content in accordance with algorithms in a thematic profile,
receiving input from a user via an API implementation to modify the thematic profile; and
receiving and storing content in accordance with the modified thematic profile.

2. The method of claim 1, wherein the modified thematic profile includes new algorithms for determining which content is to be received and stored, wherein the new algorithms are input via the API implementation.

3. The method of claim 2, wherein the new algorithms include rules for contacting authorities.

4. A computer configured to receive and store content in accordance with algorithms in a thematic profile, comprising:
one or more processors;
memory; and
a program, wherein the program is stored in the memory and configured to be executed by the one or more processors, the program including:
instructions for receiving input from a user via an API implementation to modify the thematic profile; and
instructions for receiving and storing content in accordance with the modified thematic profile.

5. A computer-program product, comprising:
a computer readable storage medium and a computer program mechanism embedded therein, the computer program mechanism comprising instructions, which when executed by a computer configured to receive and store content in accordance with algorithms in a thematic profile, cause the computer to:
receive input from a user via an API implementation to modify the thematic profile; and
receive and store content in accordance with the modified thematic profile.

6. A computer configured to receive and store content in accordance with algorithms in a thematic profile, comprising:
means for receiving input from a user via an API implementation to modify the thematic profile; and
means for receiving and storing content in accordance with the modified thematic profile.

7. A computer-implemented method comprising: at a first computer with a thematic profile of a first user,
communicating at least a portion of the thematic profile of the first user to a second computer of a second user, wherein the second computer is configured to receive and store content in accordance with the communicated portion of the thematic profile of the first user and a thematic profile of the second user.

8. The method of claim 7, wherein the communicated thematic profile includes algorithmic information.

9. The method of claim 7, wherein the communicated thematic profile includes instructions to contact one or more authorities.

10. The method of claim 9, wherein the authorities include websites with content guides.

11. The method of claim 7, wherein the authorities include websites with content reviews.

12. The method of claim 7, wherein the communicated thematic profile includes one or more metadata specifications.

13. The method of claim 12, wherein the metadata specifications concern movie, TV, music or photo information.

14. The method of claim 7, wherein communicating the thematic profile includes remote execution of code on the first computer system initiated by the second computer system.

15. A first computer with a thematic profile of a first user, comprising:
one or more processors;
memory; and
a program, wherein the program is stored in the memory and configured to be executed by the one or more processors, the program including:
instructions for communicating at least a portion of the thematic profile of the first user to a second computer of a second user, wherein the second computer is configured to receive and store content in accordance with the communicated portion of the thematic profile of the first user and a thematic profile of the second user.

16. A computer-program product, comprising:
a computer readable storage medium and a computer program mechanism embedded therein, the computer program mechanism comprising instructions, which when executed by a first computer with a thematic profile of a first user, cause the first computer to:
communicate at least a portion of the thematic profile of the first user to a second computer of a second user, wherein the second computer is configured to receive and store content in accordance with the communicated portion of the thematic profile of the first user and a thematic profile of the second user.

17. A computer-implemented method, comprising: at a first computer associated with a first user,
receiving at least a portion of a thematic profile associated with a second user from a second computer, and
receiving and storing content in accordance with the received thematic profile.

18. The method of claim 17, wherein the received thematic profile includes algorithmic information.

19. The method of claim 17, wherein the received thematic profile includes instructions to contact one or more authorities.

20. The method of claim 19, wherein the authorities include websites with content guides.

21. The method of claim 19, wherein the authorities include websites with content reviews.

22. The method of claim 17, wherein the communicated thematic profile includes one or more metadata specifications.

23. The method of claim 22, wherein the metadata specifications concern movie, TV, music or photo information.

24. The method of claim 17, wherein receiving the thematic profile includes remote execution of code on the first computer system initiated by the second computer system.

25. A first computer associated with a first user, comprising:
one or more processors;
memory; and
a program, wherein the program is stored in the memory and configured to be executed by the one or more processors, the program including:
instructions for receiving at least a portion of a thematic profile associated with a second user from a second computer; and
instructions for receiving and storing content in accordance with the received thematic profile.

26. A computer-program product, comprising:
a computer readable storage medium and a computer program mechanism embedded therein, the computer program mechanism comprising instructions, which when executed by a first computer associated with a first user, cause the first computer to:
receive at least a portion of a thematic profile associated with a second user from a second computer; and
receive and store content in accordance with the received thematic profile.

27. A first computer associated with a first user, comprising:
means for receiving at least a portion of a thematic profile associated with a second user from a second computer; and
means for receiving and storing content in accordance with the received thematic profile.

28. A computer-implemented method, comprising: at a storage server,
receiving data from a plurality of authorities;
determining content that meets a thematic profile of a user based at least on:
data received from a first authority in the plurality of authorities, and
data received from a second authority in the plurality of authorities; and
receiving and storing at least some of the determined content.

29. The method of claim 28, wherein receiving and storing at least some of the determined content includes receiving and storing at least some of the determined content in a personal library for the user.

30. The method of claim 28, wherein the data received from the first authority includes program scheduling information and the data received from the second authority includes reviewer ratings information.

31. The method of claim 30, wherein the first authority and the second authority are websites.

32. The method of claim 28, wherein the storage server is located in a home network of the user.

33. The method of claim 28, further comprising sending a request for at least some of the determined content to a remote computer.

34. The method of claim 28, further comprising serving at least some of the stored content to the user.

35. The method of claim 28, wherein the data received from the first authority includes responses to a plurality of requests from the storage server to the first authority.

36. The method of claim 28, wherein the received data from the first authority is used to adjust a request made to another authority.

37. The method of claim 28, wherein the data received from the plurality of authorities includes metadata about the content.

38. The method of claim 28, wherein the data received from the plurality of authorities includes commentary on the content.

39. The method of claim 28, wherein the data received from the plurality of authorities includes reviewer ratings of the content.

40. The method of claim 28, wherein the data received from the plurality of authorities includes maturity ratings of the content.

41. The method of claim 28, wherein the first authority is a website.

42. The method of claim 28, wherein the thematic profile is specified by the user.

43. The method of claim 28, wherein the plurality of authorities include a plurality of scheduled program guides.

44. The method of claim 28, wherein the plurality of authorities include a plurality of content guides.

45. A storage server, comprising:
one or more processors;
memory; and
a program, wherein the program is stored in the memory and configured to be executed by the one or more processors, the program including:
instructions for receiving data from a plurality of authorities;
instructions for determining content that meets a thematic profile of a user based at least on:
data received from a first authority in the plurality of authorities, and
data received from a second authority in the plurality of authorities; and
instructions for receiving and storing at least some of the determined content.

46. A computer-program product, comprising:
a computer readable storage medium and a computer program mechanism embedded therein, the computer program mechanism comprising instructions, which when executed by a storage server, cause the storage server to:
receive data from a plurality of authorities;
determine content that meets a thematic profile of a user based at least on:
data received from a first authority in the plurality of authorities, and
data received from a second authority in the plurality of authorities; and
receive and store at least some of the determined content.

47. A storage server, comprising:
means for receiving data from a plurality of authorities;
means for determining content that meets a thematic profile of a user based at least on:
data received from a first authority in the plurality of authorities, and
data received from a second authority in the plurality of authorities; and
means for receiving and storing at least some of the determined content.

48. A computer-implemented method, comprising: at a storage server with a set of content items to be obtained,
receiving data from one or more authorities on when content items in the set may be obtained;
determining an acquisition plan that optimizes which content items in the set are obtained when there are availability conflicts between content items in the set; and
obtaining content items in the list according to the plan.

49. The method of claim 48, wherein determining the acquisition plan includes evaluating alternative acquisition times to resolve an availability conflict.

50. The method of claim 48, wherein determining the acquisition plan includes superseding a user specified set of time-independent content priorities in order to circumvent an availability conflict between two or more content items in the set.

51. The method of claim 48, wherein the plan takes into account input by a user on when at least some content items in the set need to be available.

52. The method of claim 48, wherein the plan takes into account input by a user on the priority of at least some content items in the set.

53. A storage server, comprising:
one or more processors;
memory; and
a program for obtaining a set of content items, wherein the program is stored in the memory and configured to be executed by the one or more processors, the program including:
instructions for receiving data from one or more authorities on when content items in the set may be obtained;
instructions for determining an acquisition plan that optimizes which content items in the set are obtained when there are availability conflicts between content items in the set; and
instructions for obtaining content items in the list according to the plan.

54. A computer-program product, comprising:
a computer readable storage medium and a computer program mechanism embedded therein, the computer program mechanism comprising instructions for obtaining a set of content items, which when executed by a storage server, cause the storage server to:
receive data from one or more authorities on when content items in the set may be obtained;
determine an acquisition plan that optimizes which content items in the set are obtained when there are availability conflicts between content items in the set; and
obtain content items in the list according to the plan.

55. A storage server with a set of content items to be obtained, comprising:
means for receiving data from one or more authorities on when content items in the set may be obtained;
means for determining an acquisition plan that optimizes which content items in the set are obtained when there are availability conflicts between content items in the set; and
means for obtaining content items in the list according to the plan.
